(19) United States
(12) Patent Application Publication
(10) Pub. No.: US 2025/0211466 A1
(43) Pub. Date: Jun. 26, 2025

(54) Calibration for Group Delay Effects in Ranging Measurements

(71) Applicant: Cisco Technology, Inc., San Jose, CA (US)

(72) Inventors: Al Dumdei, Greenville, TX (US); Malcolm Smith, Richardson, TX (US); Jerome Henry, Pittsboro, NC (US); Matthew Silverman, Shaker Heights, OH (US); Peiman Amini, Fremont, CA (US); Ardalan Alizadeh, Campbell, CA (US)

(21) Appl. No.: 18/932,399

(22) Filed: Oct. 30, 2024

Related U.S. Application Data
(60) Provisional application No. 63/614,391, filed on Dec. 22, 2023.

(51) Int. Cl. H04L 25/02; H04L 5/00; H04W 64/00

(52) U.S. Cl. CPC H04L 25/0224; H04W 64/003; H04L 5/0007

(57) ABSTRACT

Devices, systems, methods, and processes for calibration of group delay effects in ranging measurements such as Time of Flight are described herein. Typically, ranging measurements suffer from group delay variation (GDV) caused due to propagation through a communication channel, filters, antenna, or the like. Therefore, calibration of a transmitting device and a receiving device may be performed to offset the GDV. The transmitting device may generate a channel sounding request including a multicarrier modulated signal and transmit to a receiving device via a communication channel. Each subcarrier of the multicarrier modulated signal may suffer a time delay while propagating through the communication channel. The receiving device may determine corresponding phase response of each subcarrier to determine the GDV information. The receiving device may transmit the GDV information to the transmitting device, which can generate an equalizer based on the GDV information, to calibrate one or more ToF measurements.

This application claims the benefit of U.S. Provisional Patent Application No. 63/614,391, filed Dec. 22, 2023, which is incorporated by reference herein in its entirety.

The present disclosure relates to communication networks. More particularly, the present disclosure relates to calibration for group delay effects in ranging measurements.

### BACKGROUND

With ever-increasing requirements for applications such as indoor positioning, location-based services, proximity detection, or the like, precise determination of distances between devices (such as Access Points, mobile devices, Internet of Things devices, etc.) has become important. For such ranging requirements, accurate time measurement is very important, as ranging often relies on Time of Flight (ToF) or Round-Trip Time (RTT) techniques, where even nanosecond-level precision can significantly impact accuracy.

With the use of ranging measurements that use ToF or RTT techniques, anything that changes the propagation time affects the accuracy of the measurement. For example, a ToF signal propagating through a wireless channel from a transceiver to a receiver, may suffer group delay caused by the channel and/or various filters of the receiver. Another reason that may cause group delay effect can be transmission line that uses materials causing additional delay beyond the assumed speed of light. Other causes of group delay may be distortions caused due to the design of the receiver or can be introduced through an external device such as an antenna or external filter.

### SUMMARY OF THE DISCLOSURE

Systems and methods for calibration of group delay effects in ranging measurements in accordance with embodiments of the disclosure are described herein.

In many embodiments, a device comprises a processor, a transceiver communicatively coupled to a communication channel, and a memory communicatively coupled to the processor. The memory comprises a calibration logic that is configured to transmit, via the communication channel, a channel sounding request including a multicarrier modulated signal, receive group delay variation information in response to the channel sounding request, determine, based on the group delay variation information, a phase change experienced by the multicarrier modulated signal, and generate, based on an inverse of the determined phase change, an equalizer configured for one or more Time of Flight (ToF) measurements.

In a variety of embodiments, the calibration logic is further configured to normalize a group delay effect in a ToF measurement based on the equalizer.

In a number of embodiments, the calibration logic is further configured to transmit a ToF signal via the communication channel, receive the ToF signal returned by a target device, normalize a group delay experienced by the received ToF signal based on the equalizer, and perform a ToF measurement based on the normalized ToF signal.

In several embodiments, the channel sounding request is transmitted to a receiving device communicatively coupled to the device via the communication channel.

In further embodiments, the calibration logic is further configured to transmit an action frame to the receiving device prior to transmitting the channel sounding request.

In numerous embodiments, the action frame acts as an advance notice to the receiving device for the channel sounding request.

In more embodiments, the action frame is configured to trigger a channel sounding process, including determination of the group delay variation information, at the receiving device.

In various embodiments, the action frame is configured to probe a channel sounding capability of the receiving device.

In yet more embodiments, the calibration logic is further configured to receive, based on the action frame, an action response from the receiving device, and wherein the action response is configured to indicate the channel sounding capability of the receiving device.

In still more embodiments, the multicarrier modulated signal is transmitted to the receiving device in response to receiving the action response.

In still yet more embodiments, the calibration logic is further configured to receive the group delay variation information as a part of an action frame.

In still further embodiments, the multicarrier modulated signal includes an Orthogonal Frequency Division Multiplexing signal.

In many further embodiments, the calibration logic is further configured to generate the multicarrier modulated signal comprising a plurality of subcarriers.

In yet further embodiments, the plurality of subcarriers are modulated at a common rate.

In still yet further embodiments, a device comprises a processor, a transceiver communicatively coupled to a communication channel, and a memory communicatively coupled to the processor. The memory comprises a calibration logic that is configured to receive a channel sounding request via the communication channel, wherein the channel sounding request includes a multicarrier modulated signal having a plurality of subcarriers, compare a phase of one or more of the plurality of subcarriers with a reference phase, determine group delay variation information associated with the multicarrier modulated signal based on the comparison, and transmit the group delay variation information as a response to the channel sounding request.

In several more embodiments, prior to receiving the channel sounding request, the calibration logic is further configured to receive an action frame probing a channel sounding capability of the device.

In several additional embodiments, the calibration logic is further configured to transmit, based on the action frame, an action response that is configured to indicate the channel sounding capability of the device.

In numerous additional embodiments, the calibration logic is further configured to transmit the group delay variation information as a part of an action frame.

In some more embodiments, the calibration logic is further configured to receive a ToF signal via the communication channel from a transmitting device, and return the ToF signal to the transmitting device, wherein a normalization of the returned ToF signal is based on the group delay variation information.

In one or more embodiments, a method comprises transmitting, via a communication channel, a channel sounding request including a multicarrier modulated signal, receiving group delay variation information in response to the channel sounding request, determining, based on the group delay variation information, a phase change experienced by the multicarrier modulated signal, and generating, based on an inverse of the determined phase change, an equalizer configured for one or more ToF measurements.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of a wireless network controller connected to a public network in accordance with various embodiments of the disclosure;

FIG. 2 is a conceptual depiction of a communication layer architecture in accordance with various embodiments of the disclosure;

FIG. 3 is a conceptual network diagram of various environments that implement a calibration logic in accordance with various embodiments of the disclosure;

FIG. 4 is a conceptual diagram illustrating a calibration process between a transmitting device and a receiving device in accordance with various embodiments of the disclosure;

FIG. 5 is a conceptual diagram illustrating a ToF measurement process between an initiator device and a responder device in accordance with various embodiments of the disclosure;

FIG. 6 is a flowchart showing a process for ToF measurement in accordance with various embodiments of the disclosure;

FIG. 7 is a flowchart showing a process for ToF measurement using action frame in accordance with various embodiments of the disclosure;

FIG. 8 is a flowchart showing a process for ToF measurement in accordance with various embodiments of the disclosure;

FIG. 9 a flowchart showing a process determining group delay variation by a receiving device in accordance with various embodiments of the disclosure;

FIG. 10 is a flowchart showing a process for ToF measurements of a receiving device using action frame in accordance with various embodiments of the disclosure; and

FIG. 11 is a conceptual block diagram of a device suitable for configuration with a calibration logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide a calibration process to determine the end-to-end group delay. Communication networks support various applications such as indoor positioning, location-based services, proximity detection, or the like, for precise determination of distances between devices, such as between an Access Point (AP) and a mobile device. To support such applications, ranging measurements may be performed between a transmitting device (for example, an AP, a router, a switch, a wireless network controller, or the like) and a receiving device (for example, peer APs, user devices, a power source device, Internet of Things (IoT) devices, or any other device). Ranging measurements may often use techniques such as Time-of-Flight (ToF) and Round-Trip Time (RTT) to determine the distance between the transmitting device and the receiving device. The transmitting device may determine the time it takes for a signal to travel from the transmitting device to the receiving device and in some cases, back again. The transmitting device may use various type of signals such as radio waves, sound waves, pulsed or continuous-wave light, or the like. Many a times the signal while propagating through the communication channel may suffer group delay variation that can affect the ToF measurements. Thus, a calibration process needs to be performed between the transmitting device and the receiving device to compensate for various factors, including the group delay variation.

In many embodiments, group delay can generally include delay experienced by the group of frequencies that make up the signal as it propagates through the channel. By way of non-limiting example, a time distortion of multiple nano seconds caused by the group delay effect across the frequency band can equate to several meters of inaccuracy during ranging measurements. Wider band ToF measurements are inherently more precise; however, they may be more susceptible to effects from group delay. It should be understood that because ToF measures the ToF in both directions and divides by 2, the effects would be seen in both directions. In other words, group delay may result in inaccurate ranging measurements.

In a number of embodiments, the transmitting device, to initiate the calibration process, may transmit a channel sounding request to the receiving device. The channel sounding request may include a multicarrier modulated signal and can be transmitted via the communication channel. The channel sounding request may be transmitted to assess a group delay associated with the communication channel and the receiving device. The group delay associated with the communication channel may impact ToF measurements between the transmitting device and the receiving device, and thus may be required to be determined. In a variety of embodiments, the multicarrier modulated signal, included in the channel sounding request, may have a plurality of subcarriers (e.g., frequency tones) that are modulated at a common rate but at different frequencies. In an example embodiment, the multicarrier modulated signal can be an orthogonal Frequency-Division Multiplexing (OFDM) signal.

In more embodiments, the receiving device may receive the channel sounding request, including the generated multicarrier modulated signal modulated at the common rate, to determine group delay variation information. Group delay variation may refer to the fluctuation in the time it takes for different frequency components of a signal to propagate through the communication channel. As the communication channel introduces different time delays in different subcarrier frequencies, the plurality of subcarriers of the multicarrier modulated signal may reach the receiving device at different time instances, leading to group delay variation.

In additional embodiments, the receiving device may perform a Fast Fourier transform (FFT) on the received multicarrier modulated signal to convert the time-domain signal into the frequency domain, thus obtaining complex-valued symbols for each of the subcarriers of the multicarrier modulated signal. Performing FFT on the multicarrier modulated signal may separate the multicarrier modulated signal into its individual subcarriers. In further embodiments, the receiving device may analyze the phase response of each subcarrier and compare the phase of each subcarrier with a reference phase to determine the phase shift introduced to each subcarrier by the communication channel. Thus, the receiving device may utilize the obtained phase differences to determine the group delay variation information. The group delay variation information may refer to the time delay experienced by the envelope of the multicarrier modulated signal at least due to the communication channel. In still more embodiments, the receiving device may transmit the determined group delay variation information to the transmitting device. In other words, in response to receiving the channel sounding request, the receiving device may determine and transmit the group delay variation information associated with the multicarrier modulated signal to the transmitting device.

In still additional embodiments, the transmitting device may receive the group delay variation information and may determine, based on the group delay variation information, a phase change experienced by the multicarrier modulated signal as it propagated through the communication channel. In yet more embodiments, the transmitting device may obtain an inverse of the determined phase change to generate an equalizer. The equalizer may correspond to a function which when applied to a signal returned by the receiving device to the transmitting device may reverse the delay that the signal experienced as it propagated from the transmitting device to the receiving device and then back to the transmitting device. The equalizer can be configured for one or more ToF measurements. Thus, the generated equalizer may be used to offset the group delay variation introduced in the ToF signal while performing ranging measurements to accurately determine the position of the receiving device.

In various embodiments, the prior to transmitting the channel sounding request, the transmitting device may transmit an action frame to the receiving device. The action frame may act as an advance notice to the receiving device for the channel sounding request. In several more embodiments, the action frame may trigger a channel sounding process at the receiving device. In still various embodiments, the action frame may probe a channel sounding capability of the receiving device. In other words, by transmitting the action frame, the transmitting device may probe the receiving device to determine whether the receiving device can determine the group delay variation information for the multicarrier modulated signal during the channel sounding process.

In yet various embodiments, the transmitting device may receive, based on the transmitted action frame, an action response from the receiving device. The action response may be configured to indicate whether the receiving device has the channel sounding capability or not. In a scenario where the action response indicates that the receiving device does not have the channel sounding capability, the transmitting device may not transmit the channel sounding request to the receiving device. In still yet various embodiments, the channel sounding request can also be transmitted as an action frame and can trigger the group delay variation determination at the receiving device. In several additional embodiments, the group delay variation information from the receiving device may be received as another action frame at the transmitting device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

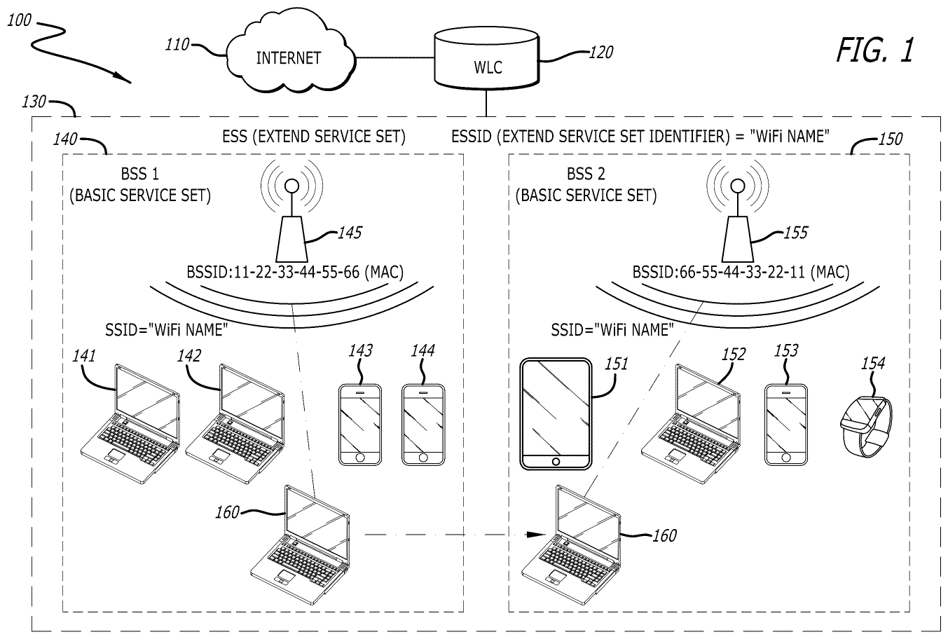

Referring to FIG. 1, a wireless local networking system 100 of a wireless network controller connected to a public network in accordance with various embodiments of the disclosure is shown. The embodiment depicted in the wireless local networking system 100 may show a scenario in which a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with a first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). Each of these devices can communicate with a second access point 155. The third notebook 160 is communicatively connected to both the first BSS 1 140 and the second BSS 2 150. In this setup, the third notebook 160 can be seen to “roam” from the physical area serviced by the first BSS 1 140 and into the physical area serviced by the second BSS 2 150.

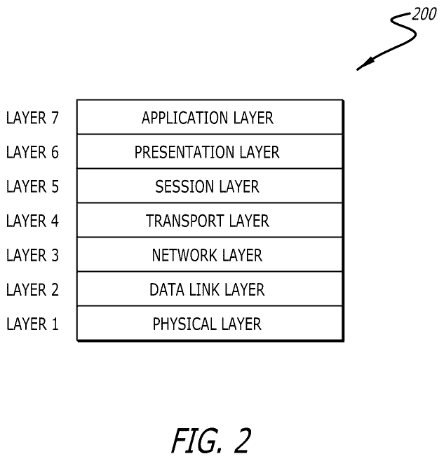

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-11 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer may create a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the Internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-11 as required to realize a particularly desired embodiment.

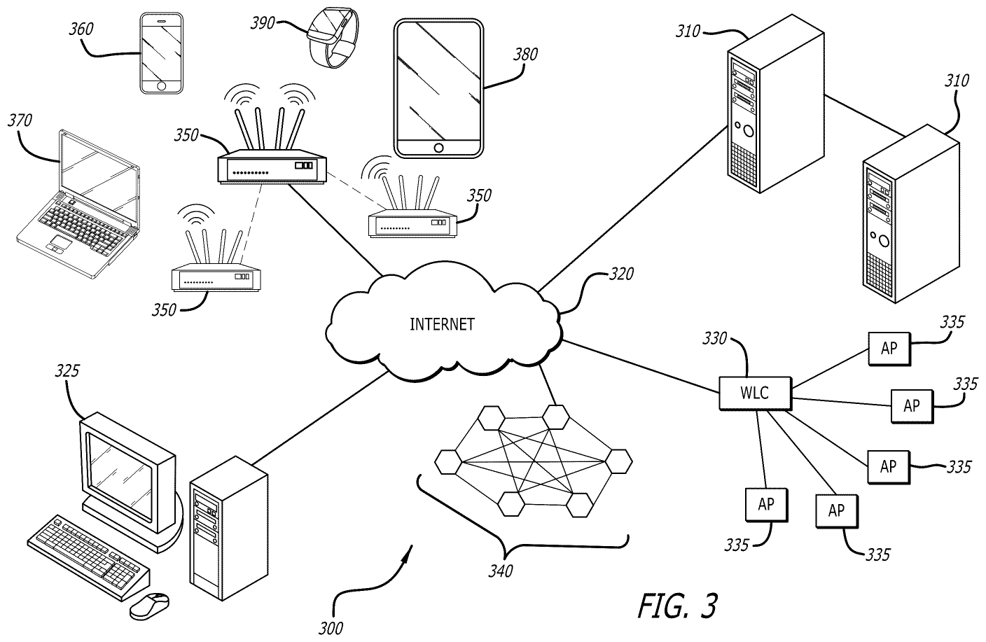

Referring to FIG. 3, a conceptual network diagram 300 of various environments that implement a calibration logic in accordance with various embodiments of the disclosure is shown. Those skilled in the art will recognize that the calibration logic can include various hardware and/or software deployments and can be configured in a variety of ways. In many embodiments, the calibration logic can be configured as a standalone device, exist as a logic in another network device, be distributed among various network devices operating in tandem, or remotely operated as part of a cloud-based network management tool. In further embodiments, one or more servers 310 can be configured with the calibration logic or can otherwise operate as the calibration logic. In many embodiments, the calibration logic may operate on one or more servers 310 connected to a communication network 320 (shown as the “Internet”). The communication network 320 can include wired networks or wireless networks. The calibration logic can be provided as a cloud-based service that can service remote networks, such as, but not limited to a deployed network 340.

However, in additional embodiments, the calibration logic may be operated as a distributed logic across multiple network devices. In the embodiment depicted in FIG. 3, a plurality of network access points (APs) 350 can operate as the calibration logic in a distributed manner or may have one specific device operate as the networking logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the calibration logic may be integrated within another network device. In the embodiment depicted in FIG. 3, a wireless LAN controller (WLC) 330 may have an integrated networking logic that the WLC 330 can use to monitor or control power consumption of the APs 335 that the WLC 330 is connected to, either wired or wirelessly. In still more embodiments, a personal computer 325 may be utilized to access and/or manage various aspects of the networking logic, either remotely or within the network itself. In the embodiment depicted in FIG. 3, the personal computer 325 communicates over the communication network 320 and can access the calibration logic of the servers 310, or the network APs 350, or the WLC 330.

In still more embodiments, the calibration logic may be equipped to perform ranging measurements. Ranging measurements may refer to the process of determining the distance between any two network devices using Wi-Fi Round-Trip Time (RTT) techniques. Performing ranging measurements may be useful for indoor positioning and navigation where GPS signals can be unavailable or unreliable. One such RTT ranging measurement technique utilized is Time of Flight (ToF) measurements. In ToF ranging measurement, distance of a first network device to a second network device may be determined by measuring the time it takes for a signal to travel from the first network device to the second network device and back. With the use of ToF measurements, anything that changes the propagation time can affect the accuracy of the measurement. In an example scenario, group delay caused by filters can cause a time distortion across a frequency band in multiple nanoseconds, which may equate to several meters of inaccuracy in such ToF measurements. Other factors that can introduce group delay may include transmission line that uses material like Polytetrafluoroethylene (PTFE) causing additional delay beyond the assumed speed of light. Such distortions can be natively a part of the design or can be introduced through an external device such as an antenna or external filter. Thus, the calibration logic may be required to offset the group delay variation introduced in the ToF signal while performing ranging measurements to accurately determine the position of the second network device.

Although a specific embodiment for various environments that the calibration logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the calibration logic may be provided as a device or software separate from the WLC 330 or the calibration logic may be integrated into the WLC 330. The elements depicted in FIG. 3 may also be interchangeable with other elements of FIGS. 1-2 and FIGS. 4-11 as required to realize a particularly desired embodiment.

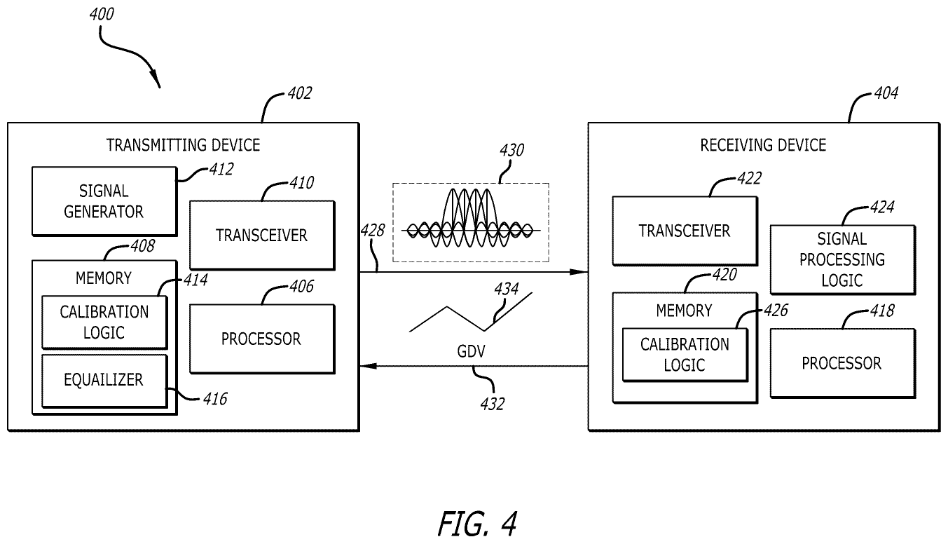

Referring to FIG. 4, a conceptual diagram 400 illustrating a calibration process between a transmitting device and a receiving device in accordance with various embodiments of the disclosure is shown. The embodiments depicted in the conceptual diagram 400 may show a scenario of calibration of Time of Flight (ToF) measurements utilized for ranging between a transmitting device 402 and a receiving device 404. In an example scenario, the transmitting device 402 may be a network device such as an Access Point (AP), a router, a switch, a wireless network controller, or the like. In many embodiments, the transmitting device 402 may be required to determine TOF, and thus, range with the receiving device 404 such as peer APs, user devices, a power source device, Internet of Things (IoT) devices, or any other device equipped with channel sounding capability. Channel sounding capability may refer to a process utilized in wireless communication systems to characterize and measure the properties (such as path loss, delay spread, fading, or the like) of a communication channel. Thus, channel sounding capability may refer to the ability to analyze and understand how a transmitted signal propagates through the environment and what effects the communication channel has on that signal. In a variety of embodiments, the transmitting device 402 may include a processor 406, a memory 408, a transceiver 410, and a signal generator 412, and the receiving device 404 may include a processor 418, a memory 420, a transceiver 422, and a signal processing engine 424.

In various embodiments, the processors 406, 418 may be implemented as one or more microprocessors, microcomputers, microcontrollers, digital signal processors, central processing units, logic circuitries, and/or any devices that process data based on operational instructions. Among other capabilities, the processors 406, 418 may be configured to fetch and execute computer-readable instructions stored in the memories 408, 420, respectively. Further examples of the processors 406, 418 may include Application-Specific Integrated Circuit (ASIC) processors, Reduced Instruction Set Computing (RISC) processors, Complex Instruction Set Computing (CISC) processors, Field-Programmable Gate Arrays (FPGAs), Digital Signal Processor (DSPs), or the like.

In yet various embodiments, the memories 408, 420 may be coupled to the processors 406, 418, respectively. The memories 408, 420 may be configured to store one or more computer-readable instructions or routines in a non-transitory computer-readable storage medium, which may be fetched and executed by respective processors 406, 418. The memories 408, 420 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memories 408, 420 in the transmitting device 402 and the receiving device 404, respectively, as described herein. In several embodiments, the memories 408, 420 may be realized in the form of a database server or a cloud storage working in conjunction with the transmitting device 402 and the receiving device 404, respectively, without departing from the scope of the disclosure.

In several more embodiments, the transceivers 410, 422 may include suitable logic, circuitry, interfaces, and/or code, executable by the circuitry, which may be configured to perform one or more operations associated with transmitting and receiving data/signals. Examples of the transceivers 410, 422 may include, but are not limited to, antennae, radio frequency transceivers, wireless transceivers, Bluetooth transceivers, Zigbee transceivers, software-defined radios, an ethernet port, or any other device configured to transmit and receive data.

In yet several embodiments, the memory 408 may store a calibration logic 414 and an equalizer 416. The calibration logic 414 may include instructions, such as a set of codes, to execute a calibration process prior to performing ranging measurements with peer devices, user devices, or the like. The calibration process may be required to ensure accurate distance measurements by correcting or compensating for various factors (e.g., group delay variations) that can affect the ToF measurements. The equalizer 416 may be equipped with signal processing techniques to reverse or compensate for the time distortion and interference incurred by a signal as it travels through the communication channel. For example, the equalizer 416 can be a function implemented by way of hardware, software, or a combination thereof to adjust the frequency response of the signal to compensate the time distortion and interference incurred by the signal.

In a number of embodiments, the transmitting device 402 may transmit a channel sounding request 428 via a communication channel 434. For example, the transmitting device 402 may transmit the channel sounding request 428 to the receiving device 404. The communication channel 434 may refer to any wireless medium such as Bluetooth, Wi-Fi, etc. utilized for wireless communications. The channel sounding request 428 may be transmitted to assess a group delay associated with the communication channel 434 and the receiving device 404, which may impact the ToF measurements between the transmitting device 402 and the receiving device 404.

In more embodiments, the calibration logic 414 may utilize the signal generator 412 to generate the channel sounding request 428. The channel sounding request 428 may include a multicarrier modulated signal 42 having a plurality of subcarriers (e.g., frequency tones) that are modulated at a common rate but at different frequencies. In an example, the multicarrier modulated signal 430 can be an Orthogonal frequency-division multiplexing (OFDM) signal. To generate the multicarrier modulated signal 430, the signal generator 412 may execute a multicarrier modulation technique where an available bandwidth is divided into multiple subcarriers, each modulated with a separate data stream. In embodiments where the multicarrier modulated signal 430 corresponds to the OFDM signal, each of the multiple subcarriers can be orthogonal to each other. Thus, the plurality of subcarriers may overlap each other without interfering to maximize the spectral efficiency. In numerous embodiments, the calibration logic 414 may further utilize the transceiver 410 to transmit the channel sounding request 428, including the generated multicarrier modulated signal 430, to the receiving device 404.

In yet more embodiments, the calibration logic 414 may utilize one or more methods of preamble synchronization. For example, the calibration logic 414 may utilize the signal generator 412 to generate a preamble. The preamble may be a known sequence of symbols that can help the receiving device 404 to synchronize with the incoming multicarrier modulated signal 430 in terms of time (e.g., symbol boundary) and frequency (e.g., carrier frequency offset). Synchronization of the multicarrier modulated signal 430 with the receiving device 404 may be required to obtain accurate phase and timing information for demodulating the multicarrier modulated signal 430 when received at the receiving device 404. The calibration logic 414 may include the generated preamble at the beginning of the multicarrier modulated signal 430 in the channel sounding request 428.

Upon transmission of the channel sounding request 428, each subcarrier in the multicarrier modulated signal 430 may experience a phase shift while travelling (or propagating) through the communication channel 434. The phase shift can be a result of an impulse response of the communication channel 434, which can vary with frequency. For example, the phase shift at a particular subcarrier frequency may be related to the time delay introduced by the communication channel 434 to the particular subcarrier frequency as the particular subcarrier frequency propagates through the communication channel 434. Thus, the communication channel 434 may introduce different time delays in different subcarrier frequencies, resulting in a group delay variation in the multicarrier modulated signal 430. Group delay variation may refer to the fluctuation in the time it takes for different frequency components of a signal to propagate through a communication channel. As the communication channel 434 introduces different time delays in different subcarrier frequencies, the plurality of subcarriers of the multicarrier modulated signal 430 may reach the receiving device 404 at different time instances, leading to group delay variation.

In still more embodiments, the memory 420 of the receiving device 404 may also include a calibration logic 426. The calibration logic 426 may receive the channel sounding request 428, including the generated multicarrier modulated signal 430 modulated at a common rate, via the transceiver 422. In additional embodiments, the calibration logic 426 may utilize the signal processing engine 424 to perform one or more processing operations on the multicarrier modulated signal 430 and determine group delay variation information 432 (denoted as “GDV” in FIG. 4) associated with the multicarrier modulated signal 430.

In an example scenario, the signal processing engine 424 may perform preamble synchronization if the channel sounding request 428 includes the preamble at the beginning of the multicarrier modulated signal 430. The signal processing engine 424 may detect the preamble by correlating the received channel sounding request 428 with a known preamble sequence. Once the preamble is detected, the signal processing engine 424 may perform timing synchronization to align with the start of the multicarrier modulated signal 430 and frequency synchronization to correct any frequency offsets between the transmitting device 402 and the receiving device 404. The signal processing engine 424 may then perform a Fast Fourier transform (FFT) on the received multicarrier modulated signal 430 to convert the time-domain signal into the frequency domain, obtaining complex-valued symbols for each of the subcarriers of the multicarrier modulated signal 430. Performing FFT on the multicarrier modulated signal 430 may separate the multicarrier modulated signal 430 into its individual subcarriers.

In further additional embodiments, the calibration logic 426 may analyze the phase response of each subcarrier and compare the phase of each subcarrier with a reference phase to determine the phase shift introduced to each subcarrier by the communication channel 434. In some more embodiments, the calibration logic 426 may select one of the plurality of subcarriers as a reference signal and may utilize the phase of the selected reference signal as the reference phase for the comparison. In an example, to compare the phase of a subcarrier with the reference phase, the signal processing engine 424 may obtain a vector dot product of a baseband signal of the subcarrier and a baseband signal of the reference signal. Baseband signal can be obtained by removing a carrier frequency from the subcarrier, effectively reducing the subcarrier to a lower frequency range. The vector dot product of the baseband signals of the subcarrier and the reference signal may enable the calibration logic 426 to obtain a phase difference between them. Similarly, the calibration logic 426 may obtain phase differences for each of the plurality of signal 430 at least due to the communication channel 434. In various embodiments, the group delay variation information 432 may provide insights regarding dispersive properties of the communication channel 434.

In furthermore embodiments, the calibration logic 426 may utilize the transceiver 422 to transmit the determined group delay variation information 432 to the transmitting device 402. In other words, in response to receiving the channel sounding request 428, the calibration logic 426 may determine and transmit the group delay variation information 432 associated with the multicarrier modulated signal 430 to the transmitting device 402.

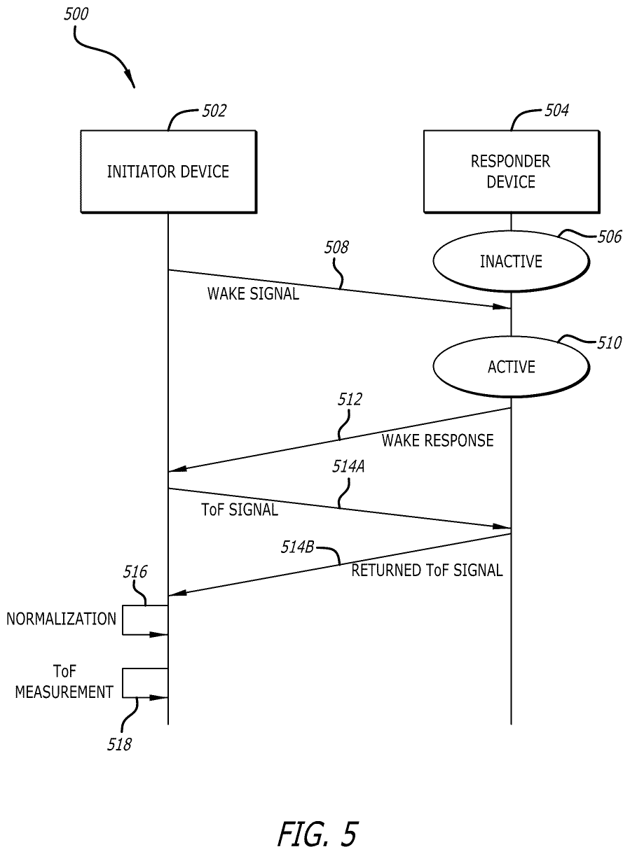

In further embodiments, the transceiver 410 may receive the group delay variation information 432 and provide it to the calibration logic 414. The calibration logic 414 may determine, based on the group delay variation information 432, a phase change experienced by the multicarrier modulated signal 430, for example, as it propagated through the communication channel 434 and one or more filters at the receiving device 404. Further, the calibration logic 414 may obtain an inverse of the determined phase change and generate the equalizer 416. In other words, the equalizer 416 may correspond to a function which when applied to a signal returned by the receiving device 404 to the transmitting device 402 may reverse the delay that the signal experienced as it travelled from the transmitting device 402 to the receiving device 404 and then back to the transmitting device 402. The equalizer 416 can be configured for one or more ToF measurements. In many more embodiments, the calibration logic 414 may be utilized to normalize a group delay effect in a ToF measurement based on the generated equalizer 416. Various embodiments for normalizing a group delay effect in a ToF measurement are described later in conjunction with FIG. 5.

In still more embodiments, the calibration logic 414 may be configured to transmit an action frame to the receiving device 404 prior to transmitting the channel sounding request 428. The action frame may act as an advance notice to the receiving device 404 for the channel sounding request 428. In several more embodiments, the action frame may be configured to trigger a channel sounding process at the receiving device 404. In still further embodiments, the action frame may be configured to probe a channel sounding capability of the receiving device 404. The channel sounding capability may refer to an ability of the receiving device 404 to determine the group delay variation information 432 for the multicarrier modulated signal 430 during the channel sounding process.

In many additional embodiments, the calibration logic 414 may be configured to receive, based on the action frame, an action response from the receiving device 404. The action response may be configured to indicate whether the receiving device 404 has the channel sounding capability or not. For example, the action response may include an information element which can be set to a first value to indicate that the receiving device 404 has the channel sounding capability or to a second value to indicate that the receiving device 404 does not have the channel sounding capability. In a scenario where the action response indicates that the receiving device 404 does not have the channel sounding capability, the transmitting device 402 may not transmit the channel sounding request to the receiving device 404.

In still yet further embodiments, the channel sounding request 428 may be transmitted as an action frame. Such an action frame may include a special information element which when set may trigger group delay variation determination at the receiving device 404. If the special information element is not set, the receiving device 404 upon receiving the channel sounding request 428 may execute regular sounding where channel state information of the communication channel is determined and transmitted to the transmitting device 402. In still yet additional embodiments, the special information element when set may trigger the group delay variation determination at the receiving device 404. In several additional embodiments, the group delay variation information 432, from the receiving device 404, may be received as another action frame at the transmitting device 402.

Although a specific embodiment depicting a calibration process between the transmitting device and the receiving device suitable for carrying out the various steps, processes, methods, and operations described herein is discussed with respect to FIG. 4, any of a variety of systems and/or processes may be utilized in accordance with embodiments of the disclosure. In further additional embodiments, the transmitting device 402 may perform the ranging measurements with a Bluetooth Low Energy (BLE) device. The elements depicted in FIG. 4 may also be interchangeable with other elements of FIGS. 1-3 and 5-11 as required to realize a particularly desired embodiment.

Referring to FIG. 5, a conceptual diagram 500 illustrating a ToF measurement process between an initiator device and a responder device in accordance with various embodiments of the disclosure is shown. The embodiments depicted in the conceptual diagram 500 may show a scenario of normalization of Time of Flight (ToF) measurements utilized for ranging between an initiator device 502 and a responder device 504. In an example scenario, the initiator device 502 may be a network device such as an AP, a router, a switch, a wireless network controller, or the like. In many embodiments, the initiator device 502 may want to determine TOF, and thus, may execute a ranging exchange with the responding device 504 such as peer APs, user devices, a power source device, Internet of Things (IoT) devices, or any other device. In still more embodiments, the initiator device 502 and the responder device 504 may operate in a master-slave configuration.

In additional embodiments, the responder device 504 may be in an inactive state 506. The inactive state of the responder device 504 may refer to a standby state, a sleep state, a scanning state, or the like during which the responder device 504 may enter into a low power mode to conserve power, when not actively transmitting or receiving any data. In further embodiments, the initiator device 502 may require to perform ranging measurements with the responder device 504. Thus, the initiator device 502 may transmit a wake signal 508 to the responder device 504. The wake signal 508 may include specific identifiers or commands that the responder device 504 identifies as a trigger to wake up and become active. The wake signal 508 may be a simple pulse, a specific sequence of bits, or a specialized packet that the responder device 504 is configured to recognize.

In further embodiments, the responder device 504, after receiving the wake signal 508, may change its state from the inactive state 506 to an active state 510. During the active state 510, the responder device 504 may initiate the transmission and reception of data, may perform specific tasks such as battery status reporting, internal diagnosis, or the like. In still further embodiments, the responder device 504 may transmit a wake response 512 to the initiator device 502. For example, the wake response 512 may include an acknowledgment (ACK) packet to indicate to the initiator device 502 that the responder device 504 has successfully received the wake signal 508 and is now in the active state 510.

Based on the received wake response 512, in still additional embodiments, the initiator device 502 may transmit a ToF signal 514A to the responder device 504 to initiate the ranging measurements (e.g., a ranging exchange). For example, the ToF signal 514A may include a multicarrier modulated signal having a plurality of subcarriers (e.g., frequency tones) that are modulated at a common rate but at different frequencies. In yet more embodiments, the ToF signal 514A may include a preamble (known sequence of symbols) that can help the responding device 504 to synchronize with the multicarrier modulated signal in terms of time (e.g., symbol boundary) and frequency (e.g., carrier frequency offset). In further examples, the ToF signal 514A can be a blink signal having a plurality of frequency tones.

In still yet more embodiments, the responder device 504 may process the received ToF signal 514A to transmit a returned ToF signal 514B to the initiator device 502. The returned ToF signal 514B may be associated with a group delay variation. For example, each subcarrier in the ToF signal 514A may experience a phase shift while travelling (or propagating) through a communication channel between the initiator device 502 and the responder device 504. The phase shift can be a result of an impulse response of the communication channel, which can vary with frequency. For example, the phase shift at a particular subcarrier frequency may be related to the time delay introduced by the communication channel to the particular subcarrier frequency as the particular subcarrier frequency propagates through the communication channel. Thus, the communication channel may introduce different time delays in different subcarrier frequencies, resulting in the group delay variation, firstly in the ToF signal 514A and then in the returned ToF signal 514B. As the communication channel introduces different time delays in different subcarrier frequencies, the plurality of subcarriers of the ToF signal 514A may reach the responder device 504 at different time instances, and then as the plurality of subcarriers are returned by the responder device 504 to the initiator device 502 as the returned ToF signal 514B, the plurality of subcarriers are again delayed by the communication channel differently, leading to the group delay variation in the returned ToF signal 514B.

In many further embodiments, the initiator device 502 may perform normalization (indicated as arrow 516) to compensate for overall group delay variation experienced by the returned ToF signal 514B. For example, the initiator device 502 may normalize the group delay experienced by the returned ToF signal 514B based on an equalizer. In various embodiments, the equalizer may be generated based on an inverse of a phase change associated with the communication channel. For example, the equalizer may correspond to a function which when applied to a signal returned by the responder device 504 to the initiator device 502 may reverse the delay that the signal experienced as it travelled from the initiator device 502 to the responder device 504 and then back to the initiator device 502. Thus, normalization may include applying the equalizer to the returned ToF signal 514B to compensate for the overall group delay variation experienced by the returned ToF signal 514B.

In many additional embodiments, the initiator device 502 may perform ToF measurement (as indicated by arrow 518) based on the normalized returned ToF signal 514B. For example, once the time delay associated with the communication channel is reversed by the equalizer, the initiator device 502 may determine the time duration (e.g., ToF) taken by the ToF signal 514A to travel from the initiator device 502 to the responder device 504 and then back to the initiator device 502 as the returned ToF signal 514B. Using the determined ToF and a speed of the ToF signal 514A/ToF signal 514B, the initiator device 502 may determine a distance (e.g., ranging measurement) between the initiator device 502 and the responder device 504. Since the ranging measurement is performed based on a group delay compensated ToF signal, the ranging measurement is more accurate and independent of group delay effect of the communication channel or other filtering components.

Although a specific embodiment depicting a ToF measurement process between an initiator device and a responder device suitable for carrying out the various steps, processes, methods, and operations described herein is discussed with respect to FIG. 5, any of a variety of systems and/or processes may be utilized in accordance with embodiments of the disclosure. In several embodiments, the initiator device 502 may refer to an Ultra-Wideband (UWB) system that may use wake signals to initiate ranging measurements with the responder device 504. The elements depicted in FIG. 5 may also be interchangeable with other elements of FIGS. 1-4 and 6-11 as required to realize a particularly desired embodiment.

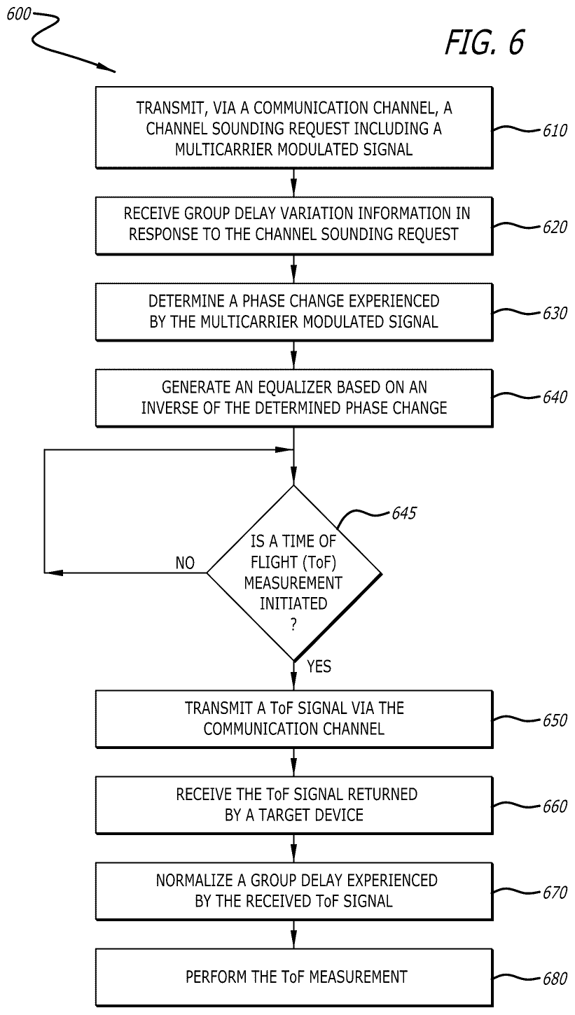

Referring to FIG. 6, a flowchart showing a process 600 for ToF measurement in accordance with various embodiments of the disclosure is shown. In many embodiments, the process 600 may transmit, via a communication channel, a channel sounding request including a multicarrier modulated signal (block 610). The process 600 may transmit the channel sounding request to a receiving device such as peer APs, user devices, a power source device, Internet of Things (IoT) devices, or any other device equipped with channel sounding capability. In a number of embodiments, the channel sounding request may be transmitted to assess (or determine) a group delay associated with the communication channel and the receiving device. Since the group delay associated with the communication channel may impact ToF measurements between the transmitting device and the receiving device, the process 600 may transmit the channel sounding request for group delay variation determination. In a variety of embodiments, the multicarrier modulated signal may include a plurality of subcarriers (e.g., frequency tones) that are modulated at a common rate but at different frequencies. For example, the multicarrier modulated signal can be an OFDM signal.

In a variety of embodiments, the process 600 may receive group delay variation information in response to the channel sounding request (block 620). Different subcarrier frequencies of the multicarrier modulated signal may suffer from different time delays introduced by the communication channel. Thus, the plurality of subcarriers of the multicarrier modulated signal may reach the receiving device at different time instances, leading to group delay variation. The group delay variation information may be received from the receiving device.

In more embodiments, the process 600 may determine a phase change experienced by the multicarrier modulated signal (block 630). Based on the group delay variation information, the process 600 may determine the phase shift experienced by each subcarrier of the multicarrier modulated signal while travelling through the communication channel. The phase shift may be a result of impulse response of the communication channel, which can vary with frequency. For example, the phase shift at a particular subcarrier frequency may be related to the time delay introduced by the communication channel to the particular subcarrier frequency as the particular subcarrier frequency propagates through the communication channel.

In additional embodiments, the process 600 may generate an equalizer based on an inverse of the determined phase change (block 640). In various embodiments, the equalizer can be a function stored in a memory of the transmitting device. Further, the process 600 can generate different equalizers for different communication channels and different receiving devices. In still various embodiments, the equalizer when applied to a signal returned by the receiving device to the transmitting device may reverse the delay that the signal experienced as it travelled from the transmitting device to the receiving device and then back to the transmitting device. The equalizer may be equipped with signal processing techniques to reverse or compensate for the time distortion and interference incurred by the signal as it travels through the communication channel. In further embodiments, the process 600 may configure the equalizer for one or more ToF measurements.

In still more embodiments, the process 600 may determine whether a ToF measurement is initiated (block 645). The process 600 may initiate the ToF measurement based on a requirement to perform ranging between the transmitting device and a target device. In an example, the target device can be any device (e.g., the receiving device or any other device) that is coupled to the transmitting device via the communication channel.

In yet various embodiments, if the ToF measurement is initiated, the process 600 may transmit a ToF signal via the communication channel (block 650). The process 600 may transmit the ToF signal from the transmitting device the target device. Examples of the target device may include an AP, a router, a switch, a wireless network controller, an IoT device, a wireless transceiver, or the like. The ToF signal may be transmitted using standard wireless communication protocols like Wi-Fi, Ultra-Wideband (UWB), or Bluetooth Low Energy (BLE). The ToF signal may be a specialized packet/frame or a regular data packet/frame with timestamps embedded within it.

In still further embodiments, the process 600 may receive the ToF signal returned by a target device (block 660). The returned ToF signal from the target device may include specific information that allows the transmitting device to calculate the round-trip time, and thus the distance. For example, the returned ToF signal may include a Time of Arrival (ToA) of the ToF signal at the target device. Further, the ToF signal returned by the target device may have experienced the group delay, while travelling back and forth via the communication channel, which can distort the ToF measurements.

In still additional embodiments, the process 600 may normalize a group delay experienced by the received ToF signal (block 670). For example, the process 600 may normalize the group delay experienced by the received ToF signal based on the equalizer. In other words, the process 600 may apply the equalizer to the returned ToF signal compensate or cancel out the group delay effect.

In still yet more embodiments, the process 600 may perform the ToF measurement (block 680). Upon normalization, the process 600 may determine the ToA of the returned ToF signal at the transmitting device. Further, the process 600 may perform the ToF measurement by determining an RTT for the ToF signal based on a time of transmission of the ToF signal towards the target device, the ToA indicated in the normalized ToF signal, and the ToA of the returned signal at the transmitting device. Based on the RTT of the ToF signal, the process 600 may estimate the distance between the transmitting device and the target device. Considering an example scenario, if the transmitting device is a Wi-Fi signal, assuming no processing delay at the target device, if the ToF is found to be 10 nanoseconds, the distance can be calculated as a product of the ToF and the speed of light, which in this example is 3 meters. In several embodiments, if the ToF measurement is not initiated, the process 600 may monitor whether the ToF measurement is initiated or not (block 645).

Although a specific embodiment depicting a process of ToF measurement suitable for carrying out the various steps, processes, methods, and operations described herein is discussed with respect to FIG. 6, any of a variety of systems and/or processes may be utilized in accordance with embodiments of the disclosure. In several more embodiments, the process 600 may perform normalization for clock offset between the clocks of transmitting device and the target device. The differences in clock synchronization between the transmitting device and the target device may cause errors in the ToF measurements. Thus, the normalization may involve compensating for these clock offsets by either using known reference points or by exchanging multiple timestamps. The elements depicted in FIG. 6 may also be interchangeable with other elements of FIGS. 1-5 and 7-11 as required to realize a particularly desired embodiment.

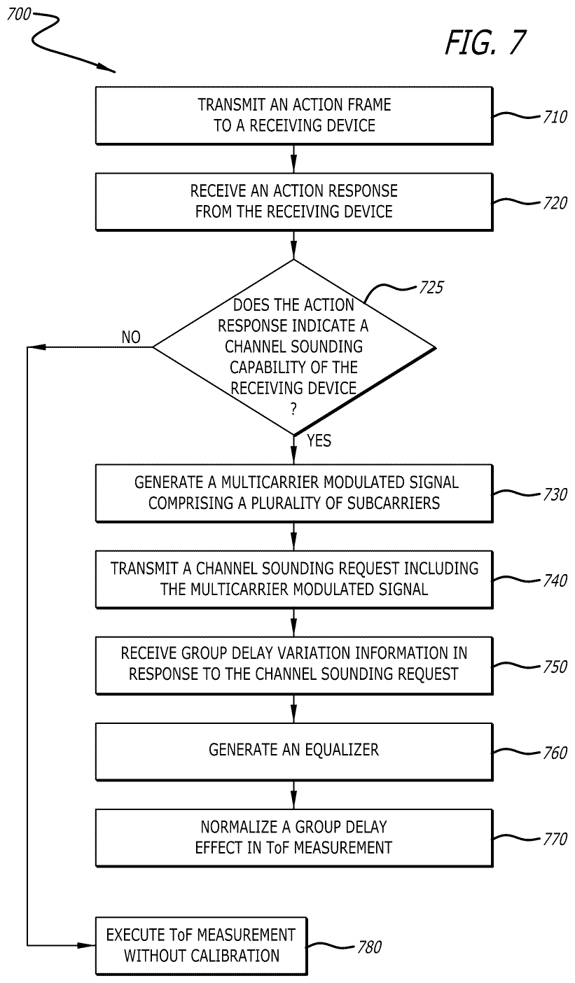

Referring to FIG. 7, a flowchart showing a process 700 for ToF measurement using action frame in accordance with various embodiments of the disclosure is shown. In many embodiments, the process 700 may transmit an action frame to a receiving device (block 710). In wireless communication, especially in the context of Wi-Fi networks, action frame may be a type of management frame. The action frame can be used to facilitate specific actions between a transmitting device and a receiving or a target device, such as initiating a process, requesting a service, or responding to a particular event. In a number of embodiments, the action frame may act as an advance notice to the receiving device for a channel sounding request. In a variety of embodiments, the action frame may be configured to trigger a channel sounding process at the receiving device or to probe a channel sounding capability of the receiving device.

In more embodiments, the process 700 may receive an action response from the receiving device (block 720). The action response may be configured to indicate whether the receiving device has the channel sounding capability or not. In additional embodiments, the process 700 may determine whether the action response indicate a channel sounding capability of the receiving device (block 725). In an example scenario, the action response may include an information element which can be set to a first value to indicate that the receiving device has the channel sounding capability or to a second value to indicate that the receiving device does not have the channel sounding capability.

If the action response indicates that the receiving device has the channel sounding capability, in further embodiments, the process 700 may generate a multicarrier modulated signal comprising a plurality of subcarriers (block 730). The plurality of subcarriers of the generated multicarrier modulated signal may be modulated at a common rate but at different frequencies. For example, the multicarrier modulated signal can be an OFDM signal, where each of the multiple subcarriers are orthogonal to each other.

In still more embodiments, the process 700 may transmit a channel sounding request including the multicarrier modulated signal (block 740). The process 700 may transmit the channel sounding request including the multicarrier modulated signal via a communication channel such as Bluetooth, Wi-Fi, etc. utilized for wireless communications or a wired medium. In still further embodiments, the channel sounding request including the multicarrier modulated signal may be transmitted as an action frame. Such an action frame may include a special information element which when set may trigger group delay variation determination at the receiving device.

In still further embodiments, the process 700 may receive group delay variation information in response to the channel sounding request (block 750). The process 700 may translate the phase difference of each subcarrier to a group delay variation of the corresponding subcarrier. Group delay variation may refer to the fluctuation in the time it takes for different frequency components of a signal to propagate through a communication channel. The group delay variations of the plurality of subcarriers may be collectively referred to as the group delay variation information. The group delay variation information may refer to the time delay experienced by the envelope of the multicarrier modulated signal at least due to the communication channel.

In still additional embodiments, the process 700 may generate an equalizer (block 760). The process 700 may obtain an inverse of the determined phase change to generate the equalizer. The equalizer may correspond to a function that when applied to a signal returned by the receiving device to the transmitting device may reverse the delay that the signal experienced as it travelled from the transmitting device to the receiving device and then back to the transmitting device. In yet more embodiments, the equalizer can be configured for one or more ToF measurements.

In still yet more embodiments, the process 700 may normalize a group delay effect in ToF measurement (block 770). The process 700 may normalize the group delay effect in a ToF measurement for a target device (e.g., the receiving device) based on the generated equalizer. The normalization of group delay effect may refer to the process of adjusting the raw ToF data to correct for various environmental factors, multipath effect, clock offset, or the like that could otherwise distort the measurement. The process 700 includes the normalization step to ensure that the ToF measurements accurately reflect the true distance between the transmitting device (such as an access point) and a target device (such as a user device).

In many further embodiments, if the action response does not indicate a channel sounding capability of the receiving device, the process 700 may execute ToF measurement without calibration (block 780). In an example scenario, if the action response indicates that the receiving device does not have the channel sounding capability, the transmitting device may not transmit the channel sounding request to the receiving device. Thus, the process 700 may execute ToF measurement without considering the group delay effect.

Although a specific embodiment depicting a process of ToF measurement using action frame suitable for carrying out the various steps, processes, methods, and operations described herein is discussed with respect to FIG. 7, any of a variety of systems and/or processes may be utilized in accordance with embodiments of the disclosure. In still yet further embodiments, the process 700 may receive the group delay variation information from the receiving device as another action frame. Further, the equalizer may be updated to accommodate any changes to the communication channel. The elements depicted in FIG. 7 may also be interchangeable with other elements of FIGS. 1-6 and 8-11 as required to realize a particularly desired embodiment.

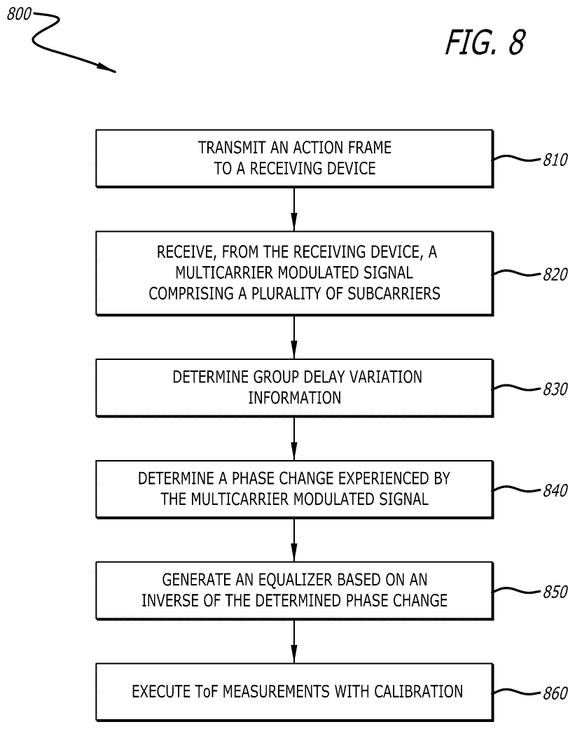

Referring to FIG. 8, a flowchart showing a process 800 for ToF measurement in accordance with various embodiments of the disclosure is shown. In many embodiments, the process 800 may transmit an action frame to a receiving device (block 810). In various embodiments, the action frame may be transmitted by a transmitting device, for example, an AP, a router, an IoT device, a network node, or the like. In a number of embodiments, the action frame may cause the receiving device to transmit a multicarrier modulated signal to the transmitting device for group delay variation determination.

In more embodiments, the process 800 may receive, from the receiving device, the multicarrier modulated signal comprising a plurality of subcarriers (block 820). The process 800 may receive the multicarrier modulated signal from the receiving device in response to the action frame. In additional embodiments, the multicarrier modulated signal received from the receiving device may have experienced group delay while propagating via a communication channel, for example, a wired medium or a wireless medium.

In further embodiments, the process 800 may determine group delay variation information (block 830). The group delay variations of the plurality of subcarriers of the multicarrier modulated signal may be collectively referred to as the group delay variation information. The group delay variation information may refer to the time delay experienced by the envelope of the multicarrier modulated signal at least due to the communication channel. In an example scenario, the transmitting device may perform preamble synchronization if a preamble is included at the beginning of the multicarrier modulated signal. The transmitting device may detect the preamble by correlating the multicarrier modulated signal with a known preamble sequence. Once the preamble is detected, the transmitting device may perform timing synchronization to align with the start of the multicarrier modulated signal 430 and frequency synchronization to correct any frequency offsets between the transmitting device and the receiving device. The transmitting device may then perform an FFT on the received multicarrier modulated signal, analyze a phase response of each subcarrier, and compare the phase of each subcarrier with a reference phase to determine the phase shift introduced to each subcarrier by the communication channel. In an example, to compare the phase of a subcarrier with the reference phase, the transmitting device may obtain a vector dot product of a baseband signal of the subcarrier and a baseband signal of a reference signal. The vector dot product of the baseband signals of the subcarrier and the reference signal may enable the transmitting device to obtain a phase difference between them. Similarly, the transmitting device may obtain phase differences for each of the plurality of subcarriers. In numerous additional embodiments, the transmitting device may utilize the obtained phase differences to determine the group delay variation information.

In still more embodiments, the process 800 may determine a phase change experienced by the multicarrier modulated signal (block 840). The process 800 may determine the phase change experienced by the multicarrier modulated signal based on the determined group delay variation information. In still further embodiments, the process 800 may determine the phase change experienced by each subcarrier of the multicarrier modulated signal while travelling through the communication channel. The phase change may be a result of impulse response of the communication channel, which can vary with frequency.

In still additional embodiments, the process 800 may generate an equalizer based on an inverse of the determined phase change (block 850). The process 800 may generate the equalizer based on a function that when applied to a signal received from the receiving device may reverse the delay that the signal experienced as it travelled from the receiving device to the transmitting device.

In yet more embodiments, the process 800 may execute ToF measurements with calibration (block 860). The process 800 may utilize the equalizer to perform accurate ToF measurements and determine the distance of the receiving device from the transmitting device. The calibration process by utilizing the equalizer in the ToF measurements provides improvements in accuracy and reliability of distance estimations.

Although a specific embodiment depicting a process of ToF measurement suitable for carrying out the various steps, processes, methods, and operations described herein is discussed with respect to FIG. 8, any of a variety of systems and/or processes may be utilized in accordance with embodiments of the disclosure. In yet more embodiments, the process 800 may receive a response to the action frame transmitted to the receiving device before receiving the multicarrier modulated signal. The elements depicted in FIG. 8 may also be interchangeable with other elements of FIGS. 1-7 and 9-11 as required to realize a particularly desired embodiment.

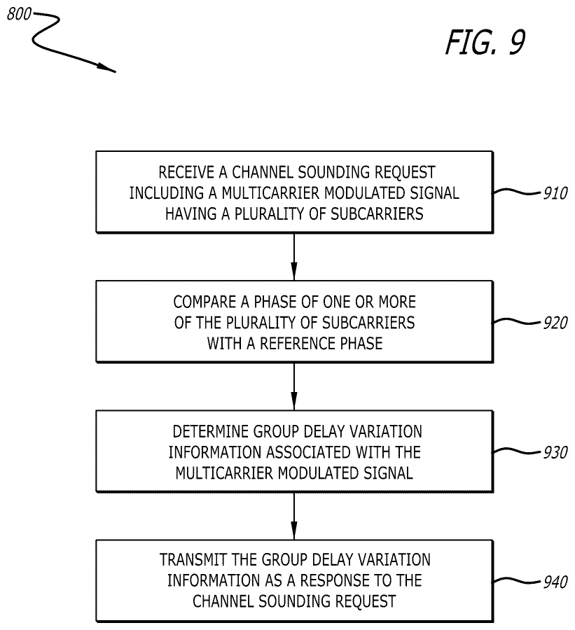

Referring to FIG. 9, a flowchart showing a process 900 determining group delay variation by a receiving device in accordance with various embodiments of the disclosure is shown. In many embodiments, the process 900 may receive a channel sounding request including a multicarrier modulated signal having a plurality of subcarriers (block 910). The channel sounding request may be received by the receiving device from a transmitting device. The process 900 may receive an action frame including the channel sounding request. The plurality of subcarriers of the multicarrier modulated signal may be modulated at a common rate but at different frequencies. In various embodiments, the multicarrier modulated signal can be an OFDM signal.

In a number of embodiments, the process 900 may compare a phase of one or more of the plurality of subcarriers with a reference phase (block 920). In yet various embodiments, the process 900 may perform preamble synchronization if the channel sounding request includes a preamble at the beginning of the multicarrier modulated signal. Once the preamble is detected, the process 900 may perform timing synchronization to align with the start of the multicarrier modulated signal and frequency synchronization to correct any frequency offsets between the transmitting device and the receiving device. The process 900 may then perform an FFT on the received multicarrier modulated signal to convert the time-domain signal into the frequency domain, separating the multicarrier modulated signal into its individual subcarriers. The process 900 may analyze the phase response of each subcarrier and compare the phase of each subcarrier with a reference phase to determine the phase shift introduced to each subcarrier by the communication channel. In some more embodiments, the process 900 may select one of the plurality of subcarriers as a reference signal and may utilize the phase of the selected reference signal as the reference phase for the comparison. Thus, the process 900 may obtain phase differences for each of the plurality of subcarriers by comparing the phase of one or more of the plurality of subcarriers with the reference phase.

In more embodiments, the process 900 may determine group delay variation information associated with the multicarrier modulated signal (block 930). The process 900 may utilize the obtained phase differences to determine the group delay variation information associated with the multicarrier modulated signal. For example, the process 900 may translate the phase difference of each subcarrier to a group delay variation of the corresponding subcarrier. The group delay variations of the plurality of subcarriers may be collectively referred to as the group delay variation information.

In additional embodiments, the process 900 may transmit the group delay variation information as a response to the channel sounding request (block 940). In response to receiving the channel sounding request, the process 900 may determine and transmit the group delay variation information associated with the multicarrier modulated signal to the transmitting device for calibration of ToF measurements.

Although a specific embodiment depicting determination of group delay variation by a receiving device suitable for carrying out the various steps, processes, methods, and operations described herein is discussed with respect to FIG. 9, any of a variety of systems and/or processes may be utilized in accordance with embodiments of the disclosure. In still more embodiments, the receiving device may perform Binary Phase-Shift Keying (BPSK), Quadrature Phase-Shift Keying (QPSK), Quadrature Amplitude Modulation (QAM), or other modulation techniques suitable for OFDM signals to generate the multicarrier modulated signal. The elements depicted in FIG. 4 may also be interchangeable with other elements of FIGS. 1-8 and 10-11 as required to realize a particularly desired embodiment.

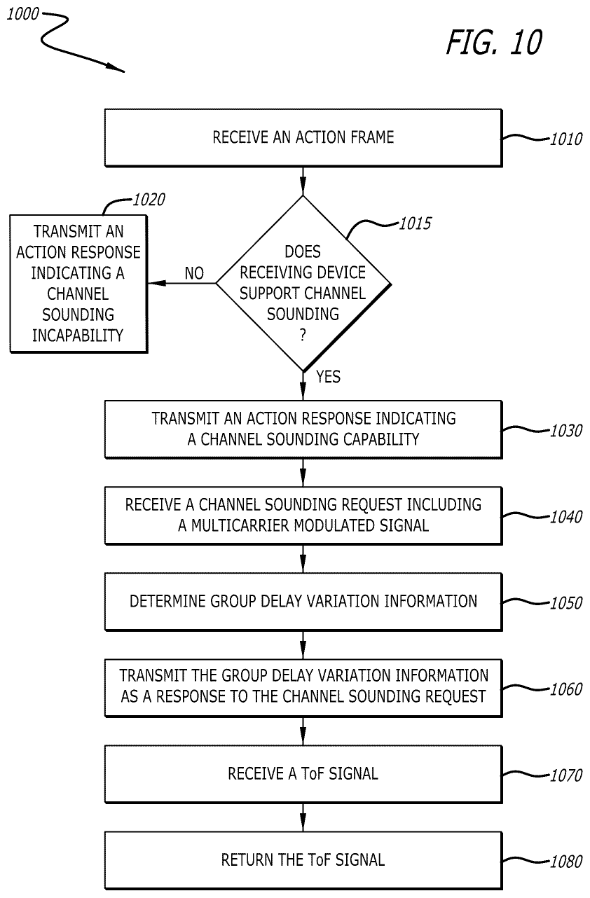

Referring to FIG. 10, a flowchart showing a process 1000 for ToF measurements of a receiving device using action frame in accordance with various embodiments of the disclosure is shown. In many embodiments, the process 1000 may receive an action frame (block 1010). The action frame may be received by the receiving device. The action frame may act as an advance notice to the receiving device for a channel sounding request. In a number of embodiments, the action frame may be configured to trigger the channel sounding process at the receiving device. In a variety of embodiments, the action frame may be configured to probe the channel sounding capability of the receiving device. The channel sounding capability may refer to an ability of the receiving device to determine group delay variation information for multicarrier modulated signal received during the channel sounding process.

In more embodiments, the process 1000 may determine whether the receiving device support channel sounding (block 1015). The receiving device may generate an action response based on the action frame. The action response may be configured to indicate whether the receiving device has the channel sounding capability or not. If the receiving device does not support the channel sounding capability, in additional embodiments, the process 1000 may transmit an action response indicating a channel sounding incapability (block 1020). The action response, in an example scenario, may be set to a second value to indicate that the receiving device does not have the channel sounding capability.

If the receiving device support the channel sounding capability, in further embodiments, the process 1000 may transmit an action response indicating a channel sounding capability (block 1030). The action response may include an information element which can be set to a first value to indicate that the receiving device has the channel sounding capability. In still more embodiments, the action response may have bits or flags that can be set to indicate the channel sounding capability.

In still further embodiments, the process 1000 may receive a channel sounding request including a multicarrier modulated signal (block 1040). The process 1000 may transmit the channel sounding request including the multicarrier modulated signal via a communication channel such as Bluetooth, Wi-Fi, etc. utilized for wireless communications. In still further embodiments, the channel sounding request including the multicarrier modulated signal may be transmitted as an action frame. The multicarrier modulated signal may have a plurality of subcarriers (e.g., frequency tones) that are modulated at a common rate but at different frequencies. For example, the multicarrier modulated signal can be an OFDM signal. In embodiments where the multicarrier modulated signal corresponds to the OFDM signal, each of the multiple subcarriers are orthogonal to each other. Thus, the plurality of subcarriers may overlap each other without interfering to maximize the spectral efficiency.

In still additional embodiments, the process 1000 may determine group delay variation information (block 1050). The process 1000 may determine the group delay variation information associated with the multicarrier modulated signal. In yet more embodiments, the process 1000 may analyze the phase response of each subcarrier and compare the phase of each subcarrier with a reference phase to determine the phase shift introduced to each subcarrier by the communication channel. The process 1000 may thus utilize the obtained phase differences to determine the group delay variation information. For example, the process 1000 may translate the phase difference of each subcarrier to the group delay variation of the corresponding subcarrier. The group delay variations of the plurality of subcarriers may be collectively referred to as the group delay variation information.

In still yet more embodiments, the process 1000 may transmit the group delay variation information as a response to the channel sounding request (block 1060). The process 1000 may transmit the determined group delay variation information associated with the multicarrier modulated signal via a transceiver, such as antennae, radio frequency transceivers, wireless transceivers, Bluetooth transceivers, Zigbee transceivers, software-defined radios, an ethernet port, or any other device configured to transmit and receive data.

In many further embodiments, the process 1000 may receive a ToF signal (block 1070). The process 1000 may receive the ToF signal in response to the transmitted group delay variation information. In many additional embodiments, the process 1000 may receive a ToF signal for ranging measurements. In many additional embodiments, the process 1000 may return the ToF signal (block 1080) to a transmitting device to perform ranging measurements. The returned ToF signal may indicate a ToA of the ToF signal at the receiving device.

Although a specific embodiment depicting a of ToF measurements of a receiving device using action frame suitable for carrying out the various steps, processes, methods, and operations described herein is discussed with respect to FIG. 10, any of a variety of systems and/or processes may be utilized in accordance with embodiments of the disclosure. In yet more embodiments, the process 1000 may utilize radio frequency (RF) signals, modulated light signals, ultrasonic waves, or the like to perform ToF measurements. The elements depicted in FIG. 10 may also be interchangeable with other elements of FIGS. 1-9 and 11 as required to realize a particularly desired embodiment.

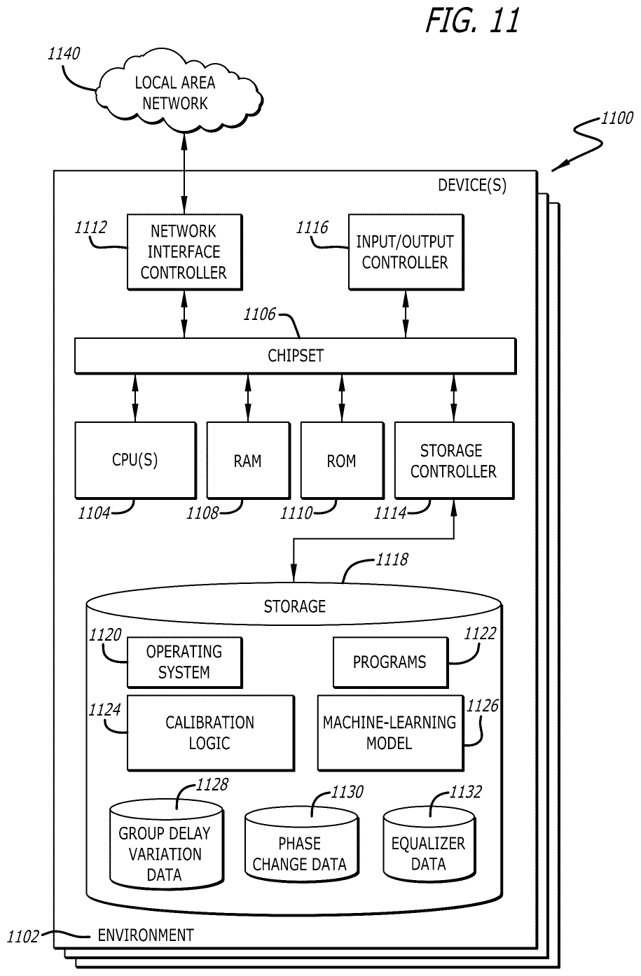

Referring to FIG. 11, a conceptual block diagram of a device 1100 suitable for configuration with a calibration logic in accordance with various embodiments of the disclosure is shown. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 11 can also illustrate an access point, a switch, or a router in accordance with various embodiments of the disclosure. The device 1100 may, in many nonlimiting examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, standard programmable central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface controller (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, applications 1122, group delay variation data 1128, phase change data 1130, and equalizer data 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system 1120 comprises the LINUX operating system. According to another embodiment, the operating system 1120 comprises the WINDOWS® SERVER operating system from MICROSOFT Corporation of Redmond, Washington. According to further embodiments, the operating system 1120 can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer executable instructions may be stored as application 1122 and transform the device 1100 by specifying how the processor(s) 1104 can transition between states, as described above. In some embodiments, the device 1100 has access to computer-readable storage media storing computer executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

In many further embodiments, the device 1100 may include a calibration logic 1124. The calibration logic 1124 can be configured to perform one or more of the various steps, processes, operations, and/or other methods. Often, the calibration logic 1124 can be a set of instructions stored within a non-volatile memory that, when executed by the processor(s)/controller(s) 1104 can carry out these steps, etc. In some embodiments, the calibration logic 1124 may be a client application that resides on a network-connected device, such as, but not limited to, a server, switch, personal or mobile computing device in a single or distributed arrangement.

In various embodiments, the calibration logic 1124 can be configured to perform one or more of the various steps, processes, operations, and/or other methods described above in conjunction with FIGS. 1-10 and can be configured to store various network compliance information, network security policies, threshold scores for monitoring user device behavior, or the like. The calibration logic 1124 can be used to perform ranging measurements to determine the distance between any two network devices using Wi-Fi RTT techniques. The ranging measurements may be useful for indoor positioning and navigation where GPS signals can be unavailable or unreliable. One such RTT ranging measurement technique utilized is Time of Flight (ToF) measurements. In several embodiments, the calibration logic 1124 when implemented at a receiving device may utilize the channel sounding capability of the receiving device to determine the group delay variation information. In an example scenario, the calibration logic 1124 may translate the phase difference of each subcarrier of the multicarrier modulated signal, received by the receiving device, to a group delay variation of the corresponding subcarrier.

In still more embodiments, the group delay variation data 1128 may refer to data representing fluctuation in the time it takes for different frequency components of a signal to propagate through the communication channel. For example, for a multicarrier modulated signal, each of the different subcarrier frequencies may experience different time delays introduced due to the communication channel, and thus may reach the receiving device at different time instances.

In still further embodiments, the phase change data 1130 stores information regarding a phase change experienced by the multicarrier modulated signal as it propagated through the communication channel. The phase change data 1130 may be based on the group delay variation information. In still additional embodiments, the equalizer data 1132 may store equalizer function for one or more ToF measurements. The equalizer data 1132 may be used to generate a function which when applied to a signal returned by the receiving device to the transmitting device may reverse the delay that the signal experienced as it propagated from the transmitting device to the receiving device and then back to the transmitting device.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more linear regression models, logistic regression models, decision trees, Naïve Bayes models, neural networks, k-means cluster models, random forest models, and/or other types of ML models 1126. In numerous embodiments, the ML model(s) 1126 can be utilized to learn a correlation between the group delay variation and channel properties. Thus, by feeding channel properties, the ML model(s) 1126 may be capable of determining the group delay variation of a known channel.

The ML model(s) 1126 can be configured to generate inferences to make predictions or draw conclusions from data. An inference can be considered the output of a process of applying a model to new data. This can occur by learning from at least the group delay variation data 1128, the phase change data 1130, and the equalizer data 1132 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a transceiver communicatively coupled to a communication channel; and
a memory communicatively coupled to the processor, wherein the memory comprises a calibration logic that is configured to:
transmit, via the communication channel, a channel sounding request including a multicarrier modulated signal;
receive group delay variation information in response to the channel sounding request;
determine, based on the group delay variation information, a phase change experienced by the multicarrier modulated signal; and
generate, based on an inverse of the determined phase change, an equalizer configured for one or more Time of Flight (ToF) measurements.

2. The device of claim 1, wherein the calibration logic is further configured to normalize a group delay effect in a ToF measurement based on the equalizer.

3. The device of claim 1, wherein the calibration logic is further configured to:
transmit a ToF signal via the communication channel;
receive the ToF signal returned by a target device;
normalize a group delay experienced by the received ToF signal based on the equalizer; and
perform a ToF measurement based on the normalized ToF signal.

4. The device of claim 1, wherein the channel sounding request is transmitted to a receiving device communicatively coupled to the device via the communication channel.

5. The device of claim 4, wherein the calibration logic is further configured to transmit an action frame to the receiving device prior to transmitting the channel sounding request.

6. The device of claim 5, wherein the action frame acts as an advance notice to the receiving device for the channel sounding request.

7. The device of claim 5, wherein the action frame is configured to trigger a channel sounding process, including determination of the group delay variation information, at the receiving device.

8. The device of claim 5, wherein the action frame is configured to probe a channel sounding capability of the receiving device.

9. The device of claim 8, wherein the calibration logic is further configured to receive, based on the action frame, an action response from the receiving device, and wherein the action response is configured to indicate the channel sounding capability of the receiving device.

10. The device of claim 9, wherein the multicarrier modulated signal is transmitted to the receiving device in response to receiving the action response.

11. The device of claim 1, wherein the calibration logic is further configured to receive the group delay variation information as a part of an action frame.

12. The device of claim 1, wherein the multicarrier modulated signal includes an Orthogonal Frequency Division Multiplexing signal.

13. The device of claim 1, wherein the calibration logic is further configured to generate the multicarrier modulated signal comprising a plurality of subcarriers.

14. The device of claim 13, wherein the plurality of subcarriers are modulated at a common rate.

15. A device, comprising:
a processor;
a transceiver communicatively coupled to a communication channel; and
a memory communicatively coupled to the processor, wherein the memory comprises a calibration logic that is configured to:
receive a channel sounding request via the communication channel, wherein the channel sounding request includes a multicarrier modulated signal having a plurality of subcarriers;
compare a phase of one or more of the plurality of subcarriers with a reference phase;
determine group delay variation information associated with the multicarrier modulated signal based on the comparison; and
transmit the group delay variation information as a response to the channel sounding request.

16. The device of claim 15, wherein prior to receiving the channel sounding request, the calibration logic is further configured to receive an action frame probing a channel sounding capability of the device.

17. The device of claim 16, wherein the calibration logic is further configured to transmit, based on the action frame, an action response that is configured to indicate the channel sounding capability of the device.

18. The device of claim 15, wherein the calibration logic is further configured to transmit the group delay variation information as a part of an action frame.

19. The device of claim 15, wherein the calibration logic is further configured to:
receive a Time of Flight (ToF) signal via the communication channel from a transmitting device; and
return the ToF signal to the transmitting device, wherein a normalization of the returned ToF signal is based on the group delay variation information.

20. A method, comprising:
transmitting, via a communication channel, a channel sounding request including a multicarrier modulated signal;
receiving group delay variation information in response to the channel sounding request;
determining, based on the group delay variation information, a phase change experienced by the multicarrier modulated signal; and
generating, based on an inverse of the determined phase change, an equalizer configured for one or more Time of Flight (ToF) measurements.
